(19) United States
(12) Patent Application Publication
(10) Pub. No.: US 2015/0107551 A1
(43) Pub. Date: Apr. 23, 2015

(54) INTAKE PORT FOR IDEAL TUMBLE FLOW

(71) Applicant: GM GLOBAL TECHNOLOGY OPERATIONS LLC, Detroit, MI (US)

(72) Inventor: Soon Seong HONG, Incheon (KR)

(73) Assignee: GM GLOBAL TECHNOLOGY OPERATIONS LLC, Detroit, MI (US)

(21) Appl. No.: 14/267,816

(22) Filed: May 1, 2014

(30) Foreign Application Priority Data
Oct. 23, 2013 (KR) 10-2013-0126762

(51) Int. Cl. F02F 1/42

(52) U.S. Cl. CPC F02F 1/4235
USPC 123/308

(57) ABSTRACT

The present invention relates to an intake port for an ideal tumble flow capable of uniformly mixing air with fuel by changing the shape of the intake port having a mounting angle into a combustion chamber and a curvature so as to form an ideal tumble flow within the combustion chamber.

This application claims priority under 35 U.S.C. §119 from Korean patent application Serial No. 10-2013-0126762, filed Oct. 23, 2013, which is incorporated herein by reference in its entirety.

### TECHNICAL FIELD

The present invention relates to an intake port, and more particularly, to an intake port for an ideal tumble flow capable of uniformly mixing air with fuel by changing the shape of the intake port having a mounting angle into a combustion chamber and a curvature so as to form an ideal tumble flow within the combustion chamber.

### BACKGROUND OF THE INVENTION

Generally, an engine is configured of a cylinder head and a cylinder block and includes a combustion chamber and a cylinder chamber formed therein. The cylinder head is provided with an intake port and an exhaust port which communicate with the combustion chamber and the cylinder chamber of the cylinder block is provided with a piston which may be linearly reciprocated therein. Therefore, the cylinder chamber is configured to transfer an expansion pressure generated by an explosion of a mixture supplied into the combustion chamber through the intake port to the piston.

Describing a typical cylinder header by way of example, the left and right of an upper portion of the combustion chamber of the cylinder header are each inclinedly provided with the intake port and the exhaust port and are each provided with an intake valve and an exhaust valve to open and close the intake port and the exhaust port.

The shape of the intake port has a close relationship to a velocity and a direction of combustion gas supplied into the cylinder and therefore combustion performance of fuel in the combustion chamber varies depending on the shape of the intake port. That is, the flow state of intake air is changed depending on the shape of the intake port and the flow of the intake air affects the combustion performance of the engine.

Further, the inside of the intake port is provided with a space in which air may rotate and an inlet of the intake port is provided with a wall surface into which air is introduced. Therefore, the flow of air is generated depending on the shape of the intake port.

Therefore, a fluid introduced from an intake manifold is introduced into the combustion chamber through the intake port and thus is combusted within the combustion chamber, and then the combustion gas is exhausted through the exhaust port.

Meanwhile, one of the most important standards to evaluate engine performance may be extent of harmful exhaust gas emissions. One of the most important factors that can reduce harmful exhaust gas emissions is the improvement of combustion performance. As one of the methods of improving the combustion performance of the engine, there is a method of reducing the amount of non-combusted fuel by mixing the compressed air introduced into the combustion chamber with injected fuel as well as possible by forming a turbulent flow, such as swirl and tumble, in the combustion chamber using the shape of the intake port.

However, the shape of the intake port is difficult to have a curvature over a certain level due to a spatial restriction and therefore the intensity of swirl which may be generated within the combustion chamber is extremely limited, such that there is a limitation in increasing the combustion efficiency of the engine by improving the combustion performance.

Further, the typical intake port forms two flow axes of tumble flow in the combustion chamber which makes the uniform mixing of fuel and air difficult, thereby causing a problem of degradation of fuel efficiency in partial load operating conditions and degradation of performance in full load operating conditions.

(Patent Document 1) KR10-2008-0050012 A

### SUMMARY OF THE INVENTION

The present invention is directed to an intake port for a tumble flow capable of improving uniform mixing efficiency of fuel and air by applying a predetermined curvature which is connected from an inlet of an intake port to a central port thereof and mounting the intake port in a combustion chamber at a predetermined angle.

Problems to be solved by the present invention are not limited to the above-mentioned embodiments, but other problems which are not mentioned may be understood by those skilled in the art from the following descriptions.

The present invention relates to an intake port for a tumble flow, including: a main port configured to be inserted into a combustion chamber; and an intake port configured to extend from one end of the main port and include a plurality of ports which are disposed in parallel with each other, wherein one surface of the main port is connected to the plurality of ports, forming a predetermined curvature Angle B, ends of the plurality of ports are formed to have a predetermined Angle A which is formed by an inclined surface contacting between the combustion chamber and the plurality of ports and an axis parallel with the plurality of ports, and the plurality of ports are formed in a direction in which a tumble axis is parallel with a crank shaft at the time of the tumble flow of air and fuel within the combustion as the plurality of ports are attached to the combustion chamber.

The predetermined Angle A may range from more than 5° to less than 90°.

The predetermined curvature Angle B may be an angle ranging from more than 5° to less than 90° which is formed by a virtual tangent line X connecting between portions of the main port and virtual lines Y1 and Y2 connecting between points of inflection of a predetermined curvature from each contact C1 and C2.

The plurality of ports may include: a first port configured to include a first port body extending from one end of the main port and a first port inlet disposed at a distal end of the first port body; and a second port configured to include a second port body extending from one end of the main port and adjacent to the first port body and a second port inlet disposed at a distal end of the second port body, wherein the predetermined curvature is formed from one end of the main port to the other end.

### BRIEF DESCRIPTION OF THE DRAWINGS

The above and other aspects, features and other advantages will be more clearly understood from the following detailed description taken in conjunction with the accompanying drawings, in which:

FIG. 1 is a perspective view of an intake port according to an embodiment of the present invention which is inserted into a combustion chamber;

FIG. 2 is a plan of the intake port of FIG. 1;

FIGS. 3A and 3B respectively are a perspective view of the intake port of FIG. 1 and a front view of an inlet of the intake port of FIG. 1;

FIG. 4 is a graph illustrating a tumble factor to a mass flow rate of a base port and the intake port according to the present invention;

FIGS. 5A and 5B are graphs illustrating a streamline of a fuel-air mixture which is compressed by passing through an intake process when a piston is located at a top dead point at 4,000 rpm full load conditions;

FIGS. 6A and 6B each are flow charts of tumble flow illustrating a distribution of turbulent energy at the location of the top dead point of the piston when the base port and the intake port according to the present invention are the same condition;

FIGS. 7A to 7C are graphs illustrating a change in a tumble index in response to a crank angle under operating conditions of each of the base port and the intake port according to the present invention;

FIGS. 8A to 8C are graphs illustrating turbulent energy in response to the crank angle under operating conditions of each;

FIGS. 9A to 9C are graphs illustrating an equivalence ratio in operating conditions of each; and

FIG. 10 is a graph illustrating the time until 10% of fuel is combusted under operating conditions of each and the time until 10% to 90% of fuel is combusted.

### DETAILED DESCRIPTION OF THE INVENTION

Components forming an intake port for a tumble flow according to an embodiment of the present invention may be integrally formed or separately formed, if necessary. Further, some of the components may be omitted according to the type of use.

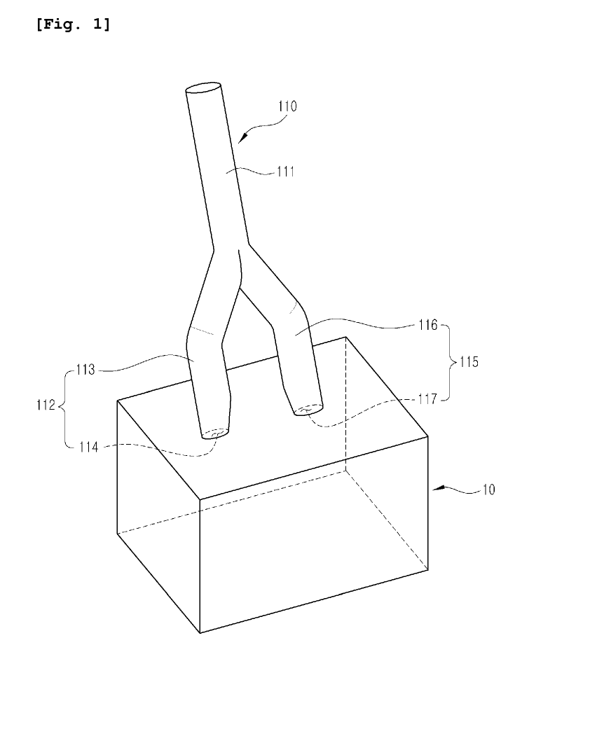

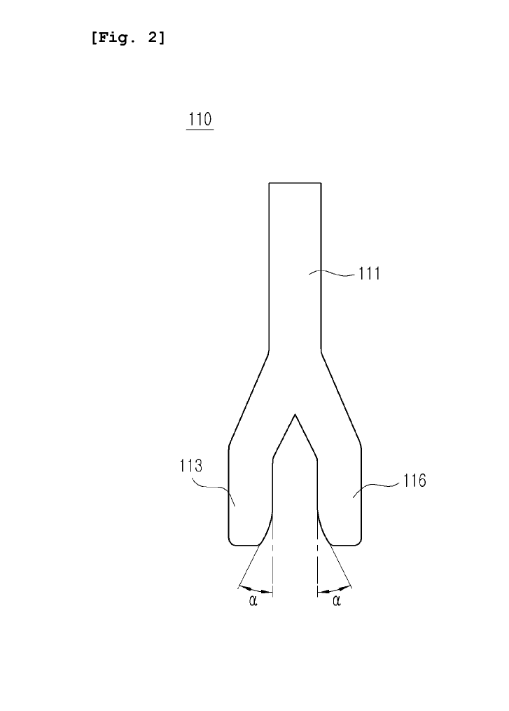

An intake port 100 for a tumble flow according to an embodiment of the present invention will be described with reference to FIGS. 1 to 10. During the process, thickness of lines, size of components, or the like, illustrated in the drawings may be exaggerated for clearness and convenience of explanation. Further, the following terminologies are defined in consideration of the functions in the present invention and may be construed in different ways by intention or practice of users and operators. Therefore, the definitions of terms used in the present description should be construed based on the content throughout the specification.

1. Description of Components

Hereinafter, the intake port 100 for a tumble flow according to an embodiment of the present invention will be described with reference to FIGS. 1 to 3.

The intake port 100 for a tumble flow according to the embodiment of the present invention includes an intake port 110 which is configured of a main port 111 inserted into a combustion chamber 10 and a plurality of ports 112 and 115 extending from one end of the main port 111.

Further, one surface of the main port 111 is connected to the plurality of ports 112 and 115 while forming a predetermined curvature Angle B, and as the plurality of ports 112 and 115 are attached to the combustion chamber 10 while forming a predetermined Angle A to the combustion chamber 10, a tumble axis is formed in a parallel direction with a crank shaft at the time of a tumble flow of air and fuel within the combustion chamber 10.

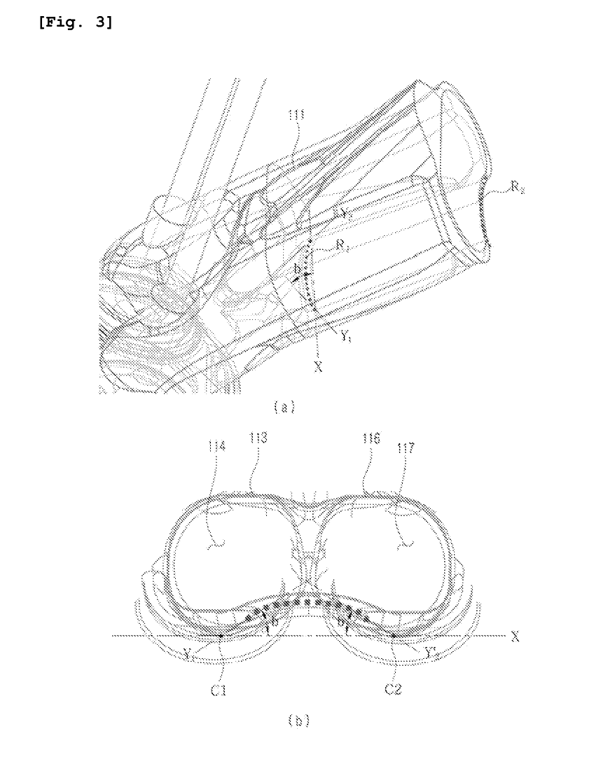

Herein, the curvature Angle B illustrated in FIGS. 3A and 3B is defined by an angle which is formed by a virtual tangent line X connecting between low end portions of the main port 111 and virtual lines Y1 and Y2 connecting between points of inflection of a predetermined curvature from each contact C1 and C2. The curvature is formed from one end R1 of the main port 111 to the other end R2 thereof at which the main port 111 contacts the plurality of ports 112 and 115.

Further, ends of the plurality of ports 112 and 115 are formed to have the predetermined Angle A which is formed by an inclined surface at which the combustion chamber 10 and the plurality of ports 112 and 115 contact each other and an axis parallel to the plurality of ports 112 and 115.

The main port 111 is a path through which air and fuel are introduced into the combustion chamber 10 and may be inserted into the combustion chamber 10, being inclined at a predetermined angle.

The plurality of ports 112 and 115 are the first port 112 and the second port 115.

The first port 112 includes a first port body 113 which extends from one end of the main port 111 and a first port inlet 114 which is disposed at a distal end of the first port body 112.

The second port 115 includes a second port body 116 which extends from one end of the main port 111 and is adjacent to the first port body 113 and a second port inlet 117 which is disposed at a distal end of the second port body 116.

Herein, the predetermined curvature angle ranges from more than 5° to less than 90° and the predetermined curvature is formed from one end of the main port 111 to the other end thereof

In particular, the predetermined angle may range from more than 5° to less than 90°.

2. Comparison of Analysis Result of Steady State and Transient of Intake Port

Hereinafter, a base port and the optimized intake port 100 according to the embodiment of the present invention will be described by comparing analysis results of between tumble flow in a steady state and a transient state.

A phenomenon of wall wetting of injected fuel appears in a PFI engine, which acts as a limitation in developing a tumble port. Therefore, a tumble axis control method for allowing an intake flow to form a strong tumble flow within a combustion chamber while minimizing wall wetting by optimizing the tumble port has been newly devised and applied.

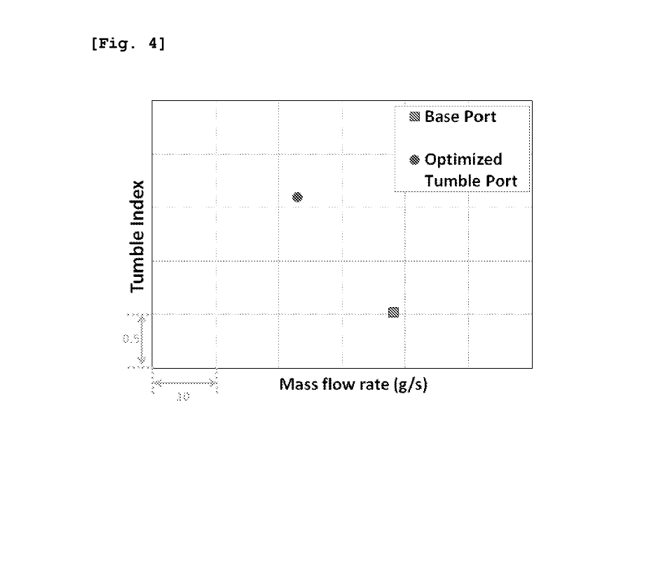

FIG. 4 illustrates a result of calculations in a steady state. FIG. 4 illustrates that a tumble value of the optimized tumble port (intake port) is 3 times as large as that of the base port. The transient analysis was performed by the optimized tumble port (intake port) selected from the steady state along with the base port.

Pressure and temperature conditions as the boundary condition between an inlet and an outlet in the transient analysis were identically applied to each port and results from operating conditions of 200 rpm at 2 bar, a 2,000 rpm full load, and a 4,000 rpm full load were compared.

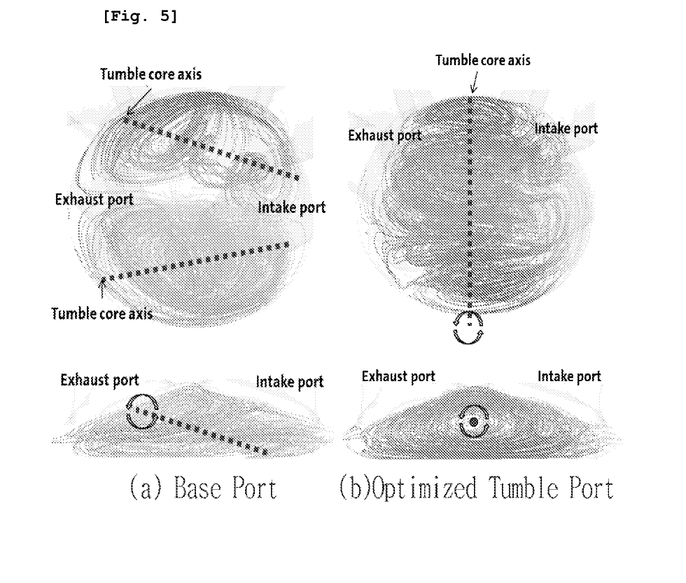

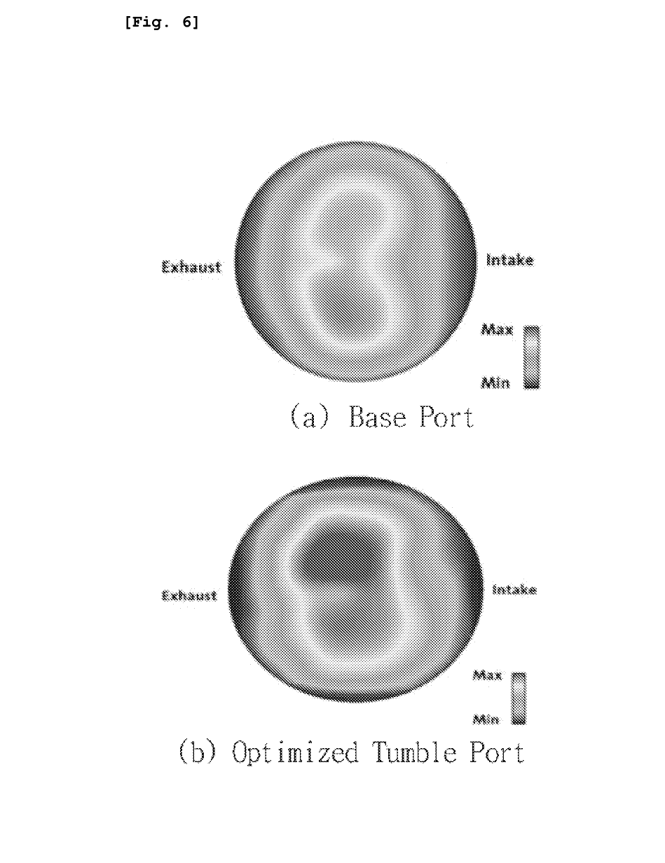

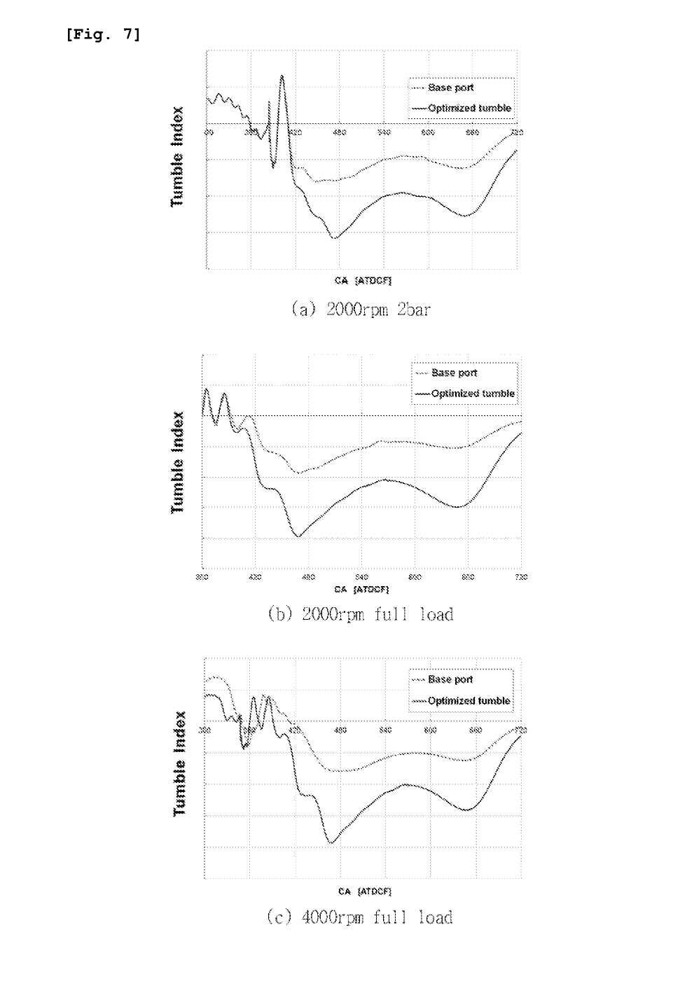

FIG. 5 illustrates a streamline of a fuel-air mixture which is compressed by passing through an intake process when a piston is located at a top dead point in 4,000 rpm full load conditions as the calculation result of the transient analysis and FIG. 7 illustrates a distribution of turbulent energy at the location of the top dead point of the piston in the same conditions. FIG. 6A illustrates a streamline of the base port which may not perform the tumble axis control, in which a peculiar aspect is that the direction of the tumble axis is perpendicular to the crank shaft, and the tumble axis and the crank shaft are illustrated. In this case, as illustrated in FIG. 7A, the turbulent energy is dispersed based on two axes which act as a factor hindering the uniform mixing of air and fuel within the combustion chamber. On the other hand, FIG. 6B illustrates the optimized tumble port (intake port) which is configured to control the tumble axis well using the optimization process, in which unlike the base port, the tumble axis is formed in a direction parallel to the crank shaft and the ideal tumble pattern based on one of the two tumble axes is shown. FIG. 7B illustrates a distribution of the turbulent energy of the optimized tumble port (intake port) and illustrates that the turbulent energy of the optimized tumble port is on average 106.8% higher than that in the combustion chamber of the base port, and the turbulent energy around an ignition plug is also on average 143.6% higher than that of the base port. The optimized tumble port (intake port) serves to increase the turbulent energy so as to enhance the uniform mixing of air and fuel within the combustion chamber, thereby implementing efficient combustion, and in particular, to form the uniform fuel-air mixture around the ignition plug in partial load operating conditions to increase combustion stability, thereby improving fuel efficiency.

FIG. 7 illustrates a change in a tumble index in response to a crank angle in each operating condition. Observing the change in the tumble index, it may be observed that the tumble flow is strongly developed during the intake process from 360 deg CA to 540 deg CA in three operating conditions. It may be observed that the so-developed tumble flow is strongly developed once more during the compression process from 540 deg CA to 720 deg CA and that the tumble flow is weakened due to the combustion chamber which reduces more towards the end of compression.

On the other hand, observing the change in the tumble index of the base port, it may be observed that the tumble flow does not reach the tumble index of the optimized tumble port (intake port) in all of the three operating conditions and the tumble flow is not strongly developed during the compression process in the 2,000 rpm full load condition.

When the tumble flow is not sufficiently generated in a medium-low speed full load condition vulnerable to a knock, the uniform mixing of fuel and air is difficult and thus the combustion efficiency is reduced, such that ignition timing is delayed due to the knock to cause degradation in performance.

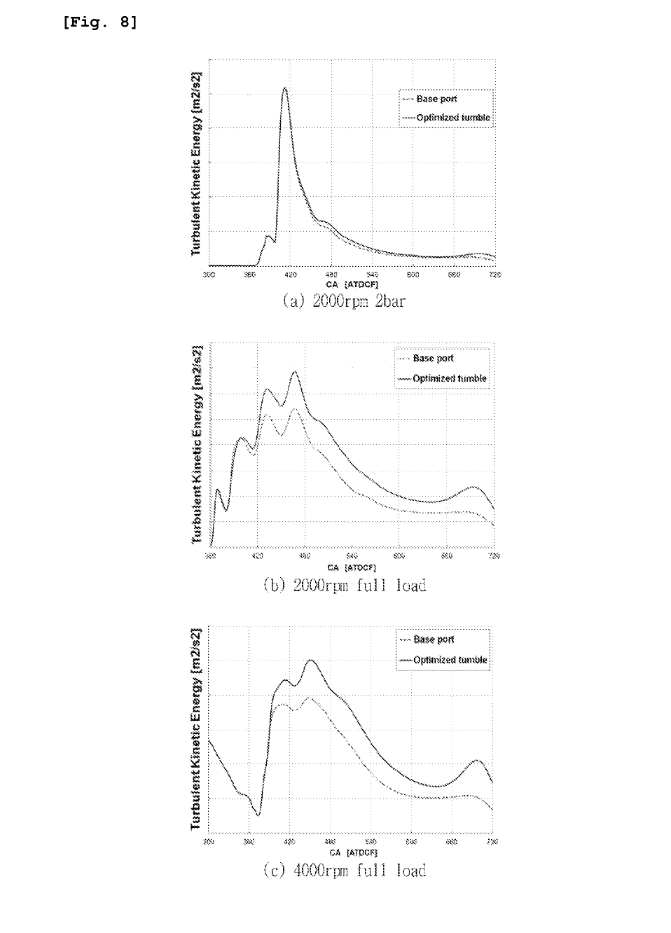

FIG. 8 illustrates the turbulent energy in response to the crank angle in each operating condition. It may be observed that the turbulent energy of the optimized tumble port (intake port) in which the strong tumble flow is formed is stronger than that of the base port.

In this way, it may be predicted that fuel and air is smoothly mixed. The characteristic appearing in the full load condition is that the turbulent energy of the optimized tumble port (intake port) is remarkably increased in the vicinity of a crank angle of 700° at an end of compression. It is considered that the turbulent energy reduces the burn duration by as much as 0 to 10% at the beginning of combustion to improve the combustion efficiency. The following Table 1 shows the increase amount in turbulent energy within the combustion chamber at the top dead point. The turbulent energy of the optimized tumble port (intake port) in 4,000 rpm full load appears about 2.1 times as large as that of the base port and appears about 2.2 times as large as that of the base port even in the conditions of 2,000 rpm at 2 bar. Increasing the turbulent energy in the partial load, not in the changing condition, improves the uniform mixing and the combustion stability to increase an EGR ratio, thereby leading to the expectation that fuel efficiency is improved.

TABLE 1

| | | 2000 rpm | 4000 rpm |
|---|---|---|---|
| (TDC) | 2000 rpm 2 bar | Full Load | Full Load |
| Base Port | Base | Base | Base |
| Optimized | 121% | 66% | 114% |
| Tumble Port | | | |
| (Intake Port) | | | |

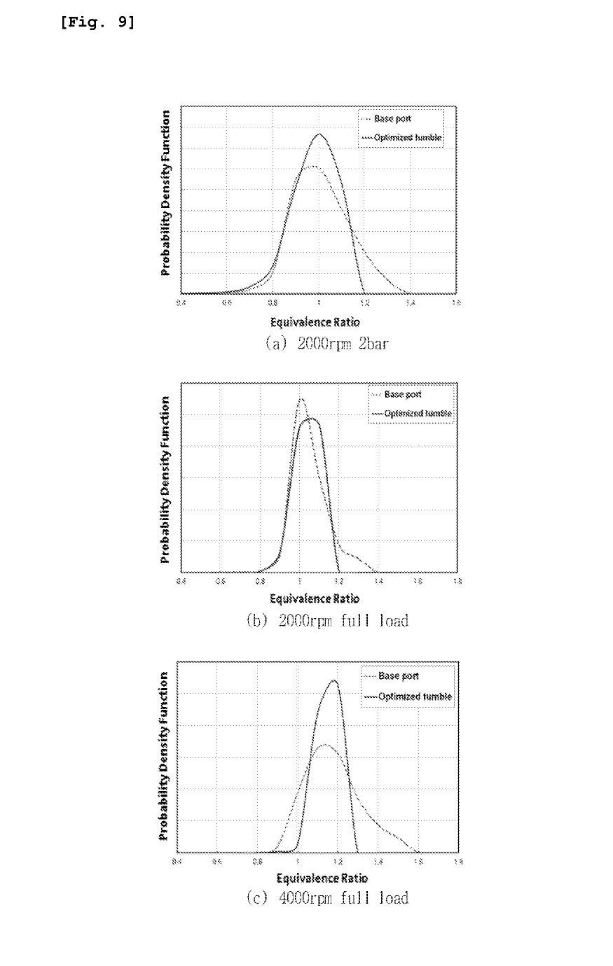

FIG. 9 illustrates an equivalence ratio Φ in each operating condition. An equivalence ratio 1 represents that air and fuel are mixed at 14.7 to 1 which is a theoretical mixing ratio and therefore the mixing state of fuel and air may be understood through the graph. In 2,000 rpm conditions, it is generally shown that the base port has many portions distributed in which fuel is rich, compared to the optimized tumble port (intake port). Considerably distributing the rich fuel suppresses fuel from being smoothly oxidized at the time of combustion, which is a cause of reduced burning velocity. In 4,000 rpm full load conditions, the base port shows both lean and rich portions of fuel compared to the optimized tumble port (intake port). The reason is that fuel and air are not smoothly mixed due to the weak tumble flow during the intake process and the tumble flow pattern which is not optimized at the end of the compression process.

Homogeneity σ representing the uniform mixing of fuel and air may be represented by the following Equation.

$$σ = \sqrt{{\sum }_{i} {( {Φ}_{i} - {Φ}_{mean} )}^{2} \cdot {f}_{i}} \qquad [ Equation 1 ]$$

In the above Equation, Φₘₑₐₙ is an average equation ratio and fᵢ is a fuel mass fraction.

TABLE 2

| | 2000 rpm | 2000 rpm Full | 4000 rpm Full |
|---|---|---|---|
| | 2 bar | Load | Load |
| Base Port | 0.14 | 0.09 | 0.13 |
| Optimized | 0.11 | 0.06 | 0.06 |
| Tumble Port | | | |
| (Intake Port) | | | |

Table 2 shows the homogeneity of each operating condition when the piston is located at the top dead point. As the value of the homogeneity is small, it is shown that air and fuel are uniformly mixed. It is shown that the homogeneity of the optimized tumble port (intake port) is on average 37% higher than that of the base port. In view of the homogeneity being increased in both full load conditions and partial load conditions, it is shown that the optimal design of the intake port plays an important role of improving performance and fuel efficiency.

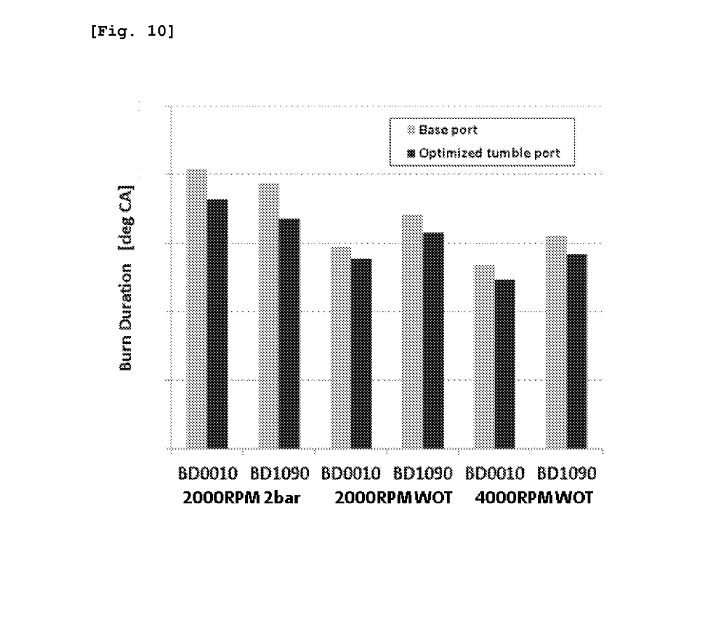

FIG. 10 is a graph illustrating the time until 10% of fuel is combusted for each operating condition and the time until 10% to 90% of fuel is combusted. It is shown that the burn duration of fuel of the tumble port (intake port) optimized in all the operating conditions is on average 9.1% faster than that of the base port. As described above, as the result of generating the strong tumble flow over the entire operating region by controlling the tumble axis well, fuel and air may be uniformly mixed and the high turbulent intensity is maintained up to the ignition timing, such that fast combustion may be conducted. In particular, it is considered that the fast initial combustion characteristics of the partial load conditions may enable stabilized combustion to contribute to the improvement in fuel efficiency. Further, it is considered that the appropriately fast combustion in full load operating conditions contributes to the improvement in knock resistance.

In summary, the combustion system to be applied to a PFI turbo engine is optimized by the flow analysis and the combustion analysis using the CFD. In developing the intake port, to maximize the tumble intensity while minimizing the wall wetting phenomenon of injected fuel, the tumble axis control method is applied and therefore efficient combustion may be conducted.

Therefore, as the tumble index calculation result, it is shown that the tumble flow of the optimized tumble port (intake port) which is controlled by one tumble axis generates a strong tumble flow even with a full load, which is a turbo boosting condition, and with a partial load, which does not have a boosting effect.

Further, it is shown that the turbulent energy of the optimized tumble port (intake port) is on average 106.8% higher than that of the base port, and it is shown that the turbulent energy around the ignition plug is also on average 143.6% higher than that of the base port.

Further, as the result of calculating the mixing homogeneity of fuel and air of the optimized tumble port (intake port), it is shown that the homogeneity of the optimized tumble port is on average 37% higher than that of the base port.

Further, it is shown that the burn duration of the tumble port (intake port) optimized in three operating conditions is on average 9.1% faster than that of the base port.

Further, it is considered that the fast initial combustion characteristics with partial load conditions may enable the stabilized combustion to contribute to the improvement in fuel efficiency and the accordingly fast combustion with full load operating conditions may improve the knock resistance to contribute to engine performance.

As set forth above, according to the present invention, the ideal tumble flow may be formed within the combustion chamber using the shape of the intake port having the specific mounting Angle And the curvature, thereby uniformly mixing air with fuel, generating the strong turbulent energy, and increasing the burning speed.

In particular, according to the present invention, the combustion efficiency in partial load operating conditions may be improved to thereby improve fuel efficiency and the burning speed in full load operating conditions may be improved to improve performance.

Further, according to the present invention, when the intake port for an ideal tumble flow is applied to the turbo engine, the intake port may serve to prevent the self-ignition phenomenon appearing in full load operating conditions, thereby greatly improving engine performance and may replace the use of the CMCV apparatus, thereby saving costs.

Further, according to the present invention, the turbulent energy of the non-applied intake port may be increased by 106.8%, the mixing homogeneity may be increased by 37%, and the burning velocity may be improved by 9.1% as compared with those of the base port.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An intake port for a tumble flow, comprising:
a main port configured to be inserted into a combustion chamber; and
an intake port configured to extend from one end of the main port and to include a plurality of ports which are disposed in parallel with each other,
wherein one surface of the main port is connected to the plurality of ports, forming a predetermined curvature Angle B,
ends of the plurality of ports are formed to have a predetermined Angle A which is formed by an inclined surface where the combustion chamber and the plurality of ports are in contact and an axis parallel with the plurality of ports, and
the plurality of ports are formed in a direction such that a tumble axis is parallel with a crank shaft at the time of the tumble flow of air and fuel within the combustion, due to the attachment of the plurality of ports to the combustion chamber.

2. The intake port for the tumble flow of claim 1, wherein the predetermined Angle A ranges from more than 5° to less than 90°.

3. The intake port for the tumble flow of claim 1, wherein the predetermined curvature Angle B is an angle ranging from more than 5° to less than 90° and is formed by a virtual tangent line X connecting between portions of the main port and virtual lines Y1 and Y2 connecting between points of inflection of a predetermined curvature respectively from contact C1 and C2.

4. The intake port for the tumble flow of claim 1, wherein the plurality of ports include:
a first port configured to include a first port body extending from one end of the main port and a first port inlet disposed at a distal end of the first port body; and
a second port configured to include a second port body extending from one end of the main port and adjacent to the first port body and a second port inlet disposed at a distal end of the second port body, and
the predetermined curvature is formed from one end of the main port to the other end.
